(19) United States
(12) Patent Application Publication
(10) Pub. No.: US 2015/0376496 A1
(43) Pub. Date: Dec. 31, 2015

(54) PHOSPHOR, DEEP ULTRAVIOLET LIGHT-EMITTING DEVICE AND PHOSPHOR PRODUCTION METHOD

(71) Applicant: Panasonic Intellectual Property Management Co., Ltd., Osaka (JP)

(72) Inventors: TAKUJI TSUJITA, Osaka (JP); HIROSHI ASANO, Osaka (JP); MASAHIRO SAKAI, Kyoto (JP); MIKIHIKO NISHITANI, Nara (JP); MASATOSHI KITAGAWA, Osaka (JP)

(21) Appl. No.: 14/733,488

(22) Filed: Jun. 8, 2015

(30) Foreign Application Priority Data
Jun. 25, 2014 (JP) 2014-130054

(51) Int. Cl. C09K 11/61; H01J 61/44

(52) U.S. Cl. CPC C09K 11/613; H01J 61/44

(57) ABSTRACT

A phosphor emitting DUV light includes particles of halogen-containing magnesium oxide, the particles satisfying 0.16°≦FWHM (420)≦0.20° wherein FWHM (420) is the full width at half maximum of a (420) diffraction peak present at a diffraction angle 2θ equal to or more than 109.0° and equal to or less than 110.0° as measured by powder X-ray diffractometry using CuKα radiation.

### BACKGROUND

1. Technical Field

The present disclosure relates to a phosphor emitting deep ultraviolet (DUV) light, a DUV light-emitting device, and a phosphor production method.

2. Description of the Related Art

DUV light having a wavelength of about 200 to 350 nm is used in various fields such as sterilization, water purification, lithography and illumination. Conventional DUV light sources that are widely used are mercury lamps. From the viewpoint of the environmental load, however, directives such as the European WEEE and Rohs have imposed increasingly strict controls on environmental toxins such as mercury. Thus, the development of light sources for replacing mercury lamps has been desired. Further, mercury lamps are point-emitting illumination sources and thus entail complicated optical designs when used in applications such as lithography where the light sources are required to illuminate a large area with a uniform intensity.

To solve such problems, Japanese Unexamined Patent Application Publications Nos. 2006-278554, 2011-124000 and 2011-193929 disclose mercury-free and surface-emitting types of DUV light-emitting devices. Specifically, Japanese Unexamined Patent Application Publication No. 2006-278554 discloses a nitride semiconductor LED emitting DUV light. Japanese Unexamined Patent Application Publication No. 2011-124000 discloses a light-emitting device in which a nitride semiconductor is caused to emit light by plasma generated by gas discharge. Japanese Unexamined Patent Application Publication No. 2011-193929 discloses a surface-emitting device in which a plurality of discharge tubes containing a UV-emitting phosphor layer are arranged in parallel and the phosphor layers are excited by UV light generated by discharge, thereby emitting UV light.

### SUMMARY

In one general aspect, the techniques disclosed here feature a deep ultraviolet (DUV) light-emitting phosphor including particles of halogen-containing magnesium oxide, the particles satisfying 0.16°≦FWHM (420)≦0.20° wherein FWHM (420) is the full width at half maximum of a (420) diffraction peak present at a diffraction angle 2θ equal to or more than 109.0° and equal to or less than 110.0° as measured by powder X-ray diffractometry using CuKα radiation.

The phosphor of the present disclosure emits DUV light with high efficiency. Thus, the use of the phosphors realizes surface-emitting devices.

It should be noted that general or specific embodiments may be implemented as a phosphor, a device, a system, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a view illustrating a configuration of a light-emitting device according to Embodiment 1;

FIG. 2 is a view illustrating a configuration of a light-emitting device according to Embodiment 2;

FIG. 3 is a view illustrating a configuration of a light-emitting device according to Embodiment 3;

FIG. 4 illustrates an example of diffraction charts obtained by powder X-ray diffractometry in Example;

FIG. 5 is a diagram illustrating relationships between FWHM (420) and emission intensity in Example and Comparative Examples 1 to 3;

FIG. 6 is a diagram illustrating examples of emission spectra obtained in Example and Comparative Examples 1 to 3; and

FIG. 7 is a diagram illustrating relationships between fluorine content and emission intensity in Example and Comparative Examples.

### DETAILED DESCRIPTION

First, the underlying knowledge forming the basis of the present disclosure will be described. The present inventors found that the conventional techniques had problems described below. The realization of the light-emitting devices disclosed in Japanese Unexamined Patent Application Publications Nos. 2006-278554 and 2011-124000 involves the epitaxial growth of nitride semiconductors such as AlGaN into multiple layers in vacuum. Consequently, complicated production processes and large-scale apparatuses are required. Further, it is difficult to manufacture such devices with a large area because of the fact that the semiconductor layers are grown on such a substrate as sapphire.

The device of Japanese Unexamined Patent Application Publication No. 2011-193929 uses a UV light-emitting rare earth phosphor such as gadolinium. Thus, it is difficult for the device to emit 311 nm or shorter wavelengths. Deep ultraviolet (DUV) light having a wavelength of 300 nm or less is required for the purpose of sterilization or clarification.

The present inventors have then carried out extensive studies in order to provide phosphors that can emit DUV light and also to provide DUV light-emitting devices using such phosphors. In the studies, the present inventors have focused attention on a (420) diffraction peak observed at a diffraction angle 2θ equal to or more than 109.0° and equal to or less than 110.0° in the X-ray diffractometry of single-crystal magnesium oxide. The present inventors have found that in contrast to the conventional theory that halogens should be avoided, the addition of a large amount of a halogen to magnesium oxide results in the broadening of the full width at half maximum of the (420) diffraction peak and the obtainable phosphor emits DUV light with high efficiency.

While it is probable that the addition of halogens broadens the full width at half maximum of other diffraction peaks of magnesium oxide, the present inventors consider that the (420) diffraction peak is particularly important because this (420) diffraction peak is present on a higher angle side and reflects the XRD signals obtained near the crystal surface with higher sensitivity than other diffraction peaks of magnesium oxide on a lower angle side such as (200) diffraction peak. Another reason is because the peak value is larger than other diffraction peaks on a higher angle side such as (422) diffraction peak and the full width at half maximum may be determined easily.

General aspects of the present disclosure are described below.

One general aspect of the present disclosure resides in a DUV light-emitting phosphor including fine particles of halogen-containing magnesium oxide, the fine particles satisfying 0.16°≦FWHM (420)≦0.20° wherein FWHM (420) is the full width at half maximum of a (420) diffraction peak present at a diffraction angle 2θ equal to or more than 109.0° and equal to or less than 110.0° as measured by powder X-ray diffractometry using CuKα radiation.

The halogen-containing magnesium oxide may be fluorine-containing magnesium oxide or chlorine-containing magnesium oxide.

The halogen-containing magnesium oxide may be the fluorine-containing magnesium oxide, and the fine particles may contain fluorine at a rate equal to or more than 1.7 atm % and equal to or less than 19.3 atm % relative to magnesium.

The fine particles may have an average particle diameter equal to or more than 100 nm to 8 μm. In the present disclosure, the average particle diameter is an average of the diameters of circumscribed circles of 3 to 100 images of particles measured by the observation of the fine particles with a scanning electron microscope (SEM). The SEM may be HITACHI S-4200. For the measurement, the fine particles may be applied onto a substrate such as glass by spraying or printing. After a phosphor layer has been formed, the particle diameter of the fine particles may be measured by observing the surface or a cross section of the phosphor layer with a SEM. Alternatively, the particle size may be measured by laser diffraction scattering particle size distribution analysis. That is, the average particle diameter may be the median particle diameter at 50% in a cumulative curve relative to the total volume (100%) of particles randomly selected from the fine particles prepared. In this case, the measurement apparatus may be MICROTRAC manufactured by NIKKISO CO., LTD.

The phosphor may emit DUV light with a wavelength equal to or more than 200 nm equal to or less than 300 nm by being excited by vacuum UV light.

The fine particles may be obtained by mixing a precursor together with a sintering auxiliary including a halogen compound as a source of the halogen, the precursor including at least one selected from the group consisting of magnesium hydroxide, magnesium carbonate, magnesium alkoxide, magnesium nitrate and magnesium acetate, and calcining the mixture at a temperature equal to or more than 1000° C. and equal to or less than 1400° C.

Another aspect of the present disclosure resides in a DUV light-emitting phosphor including fine particles of fluorine-containing magnesium oxide, the fine particles containing fluorine at a rate equal to or more than 1.7 atm % and equal to or less than 19.3 atm % relative to magnesium.

Another aspect of the present disclosure resides in a light-emitting device including a discharge space, a discharge gas sealed in the discharge space, and any of the phosphors defined hereinabove that is disposed in contact with the discharge space.

The light-emitting device may further include a first substrate including a first electrode, a second electrode and a dielectric layer covering the first electrode and the second electrode, and a second substrate disposed above the first substrate with a space therebetween so as to be opposed to the dielectric layer, the space between the first substrate and the second substrate being sealed to define the discharge space containing the discharge gas between the first substrate and the second substrate, the phosphor being supported on at least one selected from the first substrate and the second substrate so as to be in contact with the discharge space. At least one selected from the first substrate and the second substrate may include a material transmissive to the DUV light.

The material transmissive to the DUV light may be one selected from the group consisting of quartz glass, magnesium fluoride, calcium fluoride and lithium fluoride.

The light-emitting device may further include a discharge tube including the discharge space inside thereof, and at least one pair of electrodes that generate discharge in the discharge space, the phosphor being disposed inside the discharge tube.

The light-emitting device may further include a plurality of discharge tubes each including the discharge space inside thereof, at least one pair of electrodes that generate discharge in the discharge space, and a flexible sheet supporting the plurality of discharge tubes, the phosphor being disposed inside the discharge tubes.

The light-emitting device may further include a reflective layer disposed between the plurality of discharge tubes and the flexible sheet.

The discharge tube may include an envelope defining the discharge space, and the envelope may include one selected from the group consisting of quartz glass, magnesium fluoride, calcium fluoride and lithium fluoride.

Another aspect of the present disclosure resides in a phosphor production method including obtaining a mixture by mixing a precursor together with a sintering auxiliary including a halogen compound as a halogen source, the precursor including at least one selected from the group consisting of magnesium hydroxide, magnesium carbonate, magnesium alkoxide, magnesium nitrate and magnesium acetate, and a step of obtaining fine particles of halogen-containing magnesium oxide by calcining the mixture at a temperature equal to or more than 1000° C. and equal to or less than 1400° C., the fine particles satisfying 0.16°≦FWHM (420)≦0.20° wherein FWHM (420) is the full width at half maximum of a (420) diffraction peak present at a diffraction angle 2θ equal to or more than 109.0° and equal to or less than 110.0° as measured by powder X-ray diffractometry using CuKα radiation.

The precursor may include the magnesium hydroxide.

The sintering auxiliary may include at least one selected from the group consisting of magnesium fluoride, magnesium chloride, aluminum fluoride, calcium fluoride, lithium fluoride and sodium chloride.

The sintering auxiliary may be a magnesium halide.

The mixture may contain the sintering auxiliary at a rate equal to or more than 0.10 mol % and equal to or less than 1 mol % relative to the total of the precursor and the sintering auxiliary.

Embodiments and Example of the present disclosure will be described hereinbelow. However, the scope of the present disclosure is not limited to such embodiments, and various modifications thereto are possible. In the present disclosure, the term “light” refers to electromagnetic waves in the ultraviolet region including deep ultraviolet rays and vacuum ultraviolet rays.

### Embodiment 1

An embodiment of the phosphors will be described. The phosphor of the present disclosure includes fine particles of halogen-containing magnesium oxide and emits DUV light. As will be described in detail later in Example, the fine particles show a (420) diffraction peak at a diffraction angle 2θ equal to or more than 109.0° and equal to or less than 110.0° as measured by powder X-ray diffractometry using CuKα radiation. This (420) diffraction peak is assigned to magnesium oxide crystal. In-depth studies carried out by the present inventors have shown that the full width at half maximum (FWHM) of the (420) diffraction peak is closely related with the intensity of DUV light emitted by magnesium oxide. Specifically, it has been found that a phosphor including fine particles of magnesium oxide achieves a significant increase in the emission intensity of DUV light when FWHM (420), namely, the full width at half maximum of the (420) diffraction peak satisfies the following relation (1). When the CuKα radiation includes CuKα₁ radiation and CuKα₂ radiation, the peaks are separated using Lorentzian function to remove the peak obtained with the CuKα₂ radiation, and the full width at half maximum of the peak obtained with the CuKα₁ radiation is obtained as FWHM (420).

0.16°≦FWHM(420)≦0.20° (1)

While magnesium oxide is known to emit DUV light upon irradiation with excitation light, the intensity of the light that is emitted is not high. For example, single-crystal magnesium oxide emits a limited intensity of DUV light when it is excited by excitation light. The reason for this is probably because the localized energy level associated with the fluorescence emitted by the single-crystal magnesium oxide does not correspond to the energy of DUV light.

Although detailed reasons are not clear at this stage, the studies carried out by the present inventors have revealed that the emission intensity of DUV light may be increased by adding halogen atoms to magnesium oxide. The halogen is at least one selected from the group consisting of fluorine, chlorine, bromine and iodine. Specifically, it has been found that the (420) diffraction peak is allowed to satisfy the relation (1) and the emission intensity of DUV light may be significantly enhanced when the fine particles of magnesium oxide contain fluorine at a rate equal to or more than 1.7 atm % and equal to or less than 19.3 atm % relative to magnesium.

When FWHM (420) is smaller than the range defined by the relation (1), it is probable that the fine particles have relatively higher crystallinity, for example, are a single crystal. In this case, however, the emission intensity of DUV light is markedly decreased probably because of insufficient formation of the localized level capable of emitting DUV light. In the case where FWHM (420) is larger than the range defined by the relation (1), the fine particles have low crystallinity. In this case, the emission intensity of DUV light is greatly decreased probably because there are a large number of unnecessary levels other than the localized level capable of emitting DUV light. The (420) diffraction peak is a high-order diffraction peak and is observed approximately at a diffraction angle equal to or more than 109.0° and equal to or less than 110.0° regardless of the type of the powder X-ray diffractometer.

The structure and the chemical composition of the phosphor in the present embodiment are not exactly clear at this stage. It is probable that the introduction of fluorine atoms results in the formation of a level suited for the emission of DUV light in the energy levels of magnesium oxide.

For the reasons described above, the size of the fine particles is not closely associated with the emission efficiency or the emission intensity of DUV light. The size of the fine particles of the present embodiment may be a usual size for phosphors. For example, the fine particles may have an average particle diameter of 100 nm to 8 μm.

The fine particles forming the phosphor of the present embodiment emit deep ultraviolet fluorescence having a central wavelength of 230 nm by being irradiated with excitation light having a shorter wavelength than DUV light. For example, the excitation light is preferably vacuum UV light and may be 147 nm UV light.

The phosphor of the present embodiment may be produced by the following method. The phosphor of the present embodiment may be produced by mixing a precursor of magnesium oxide together with a sintering auxiliary, and calcining the mixture at a temperature equal to or more than 1000° C. and equal to or less than 1400° C.

The precursor may be at least one selected from the group consisting of magnesium hydroxide (Mg(OH)₂), magnesium carbonate (MgCO₃), magnesium alkoxide, magnesium nitrate (Mg(NO₃)₂) and magnesium acetate (Mg(CH₃COO)₂). According to the studies carried out by the present inventors, desirable emission characteristics may be obtained when magnesium hydroxide having high crystallinity is used as the precursor. This effect is probably ascribed to the enhancement of the crystallinity of the obtainable magnesium oxide particles due to the use of highly crystalline magnesium hydroxide as the precursor. The particle diameter of the obtainable fine particles may be changed by selecting the particle diameter of the compound used as the precursor. The precursor may further contain magnesium oxide as long as the precursor includes at least one selected from the above group.

The sintering auxiliary decreases the temperature of the melting of the precursor and allows the precursor to be calcined into magnesium oxide fine particles at a lower temperature. The sintering auxiliary may be at least one selected from the group consisting of magnesium fluoride (MgF₂), magnesium chloride (MgCl₂), aluminum fluoride (AlF₃), calcium fluoride (CaF₂), lithium fluoride (LiF) and sodium chloride (NaCl). If elements other than magnesium remain after the calcination, the emission characteristics may be adversely affected depending on the types of such residual elements. Desirable emission characteristics may be ensured by the use of a magnesium halide. The types of the sintering auxiliaries may be selected as appropriate.

The precursor and the sintering auxiliary may be mixed with each other by a wet method or a dry method. In the case of dry mixing, use may be made of mixers usually used in industry such as ball mills, stirrer mills, planetary ball mills, oscillating mills, jet mills and twin-cylinder mixers. Because coarse particles in the raw material may adversely affect emission characteristics, it is desirable to perform classification to make the grain size uniform.

The mixture including the precursor and the sintering auxiliary is calcined at a temperature equal to or more than 1000° C. and equal to or less than 1400° C. for 10 minutes to 5 hours. The calcination temperature and the calcination time may be appropriately controlled in accordance with various factors such as the particle diameter and the conditions for the classification of the precursor, the amount of the sintering auxiliary added, and the amount of the mixture powder. In order to obtain desired emission characteristics, the calcination may be performed while controlling the atmosphere in an oxidative atmosphere or a reductive atmosphere. Depending on the amount of the powder to be calcined, it is desirable to perform a pre-calcination step before the main calcination in order to enhance the homogeneity in the mixing of the sintering auxiliary and the precursor.

For example, the pre-calcination step may be performed in the air at a temperature equal to or more than 700° C. and equal to or less than 1000° C. for 15 minutes to 5 hours. Similarly to the main calcination step, the calcination temperature and the calcination time are desirably controlled appropriately in accordance with the variations in the aforementioned conditions. The powder obtained by the pre-calcination step is crushed and stirred by mixing. Here, the method for mixing the pre-calcined powder may be a wet method or a dry method. In the case of wet mixing, it is desirable to use a solvent that will not dissolve magnesium oxide. For example, water dissolves magnesium oxide. The calcination furnace used in each of the calcination steps may be any of furnaces usually used in industry, with examples including continuous furnaces such as pusher furnaces and batchwise furnaces such as electric furnaces and gas furnaces. The fine particles obtained by the pre-calcination step or the main calcination step may be further crushed with a device such as a ball mill or a jet mill and may be classified as required. In this manner, the grain size distribution and the fluidity of the magnesium oxide particles may be controlled.

In general, magnesium oxide having high purity may be obtained by reacting magnesium vapor with oxygen. This production method is called a gas phase oxidation process. Magnesium oxide prepared by the gas phase oxidation process is relatively nonuniform in particle diameter. In contrast, the method for producing the phosphor according to the present embodiment produces fine particles of halogen-containing magnesium oxide by the calcination of the precursor. According to the method, the grain size distribution of the fine particles may be appropriately controlled by appropriately selecting the precursor from candidates (candidates having different conditions such as the types of materials, the particle diameters and the grain size distributions) and also by appropriately controlling the conditions for the calcination of the precursor (the conditions required for the calcination such as the calcination temperature, the calcination atmosphere and the calcination time). Thus, the fine particles of magnesium oxide obtained by the method of the present embodiment have a narrower grain size distribution than particles prepared by the gas phase oxidation process. According to the present embodiment, it is possible to obtain fine particles having particle diameters in a specific range (100 nm to 8 μm, in particular, 500 nm to 2 μm).

Because of the above characteristic, the method according to the present embodiment basically does not involve a classification step, and the fine particles obtained may be directly used in fluorescent devices emitting DUV light. The elimination of a classification step simplifies the process and is highly advantageous in terms of production efficiency and cost. Further, the method of the present embodiment does not require a special apparatus in contrast to the gas phase oxidation process and is advantageously applicable to general conventional ceramic powder production steps. Thus, effective reduction of production costs is expected.

The fine particles of halogen-containing magnesium oxide obtained by the method of the present embodiment have a smaller specific surface area (BET) than fine particles prepared by the gas phase oxidation process. With a small specific surface area, the fine particles are prevented from unnecessary adsorption of gas, namely, exhibit excellent adsorption resistance. Thus, phosphors may be realized which are resistant to change in emission characteristics or degradation with time due to gas adsorption.

In the presence of excessive passage of gas in the atmosphere in the calcination furnace during the calcination steps including main calcination and pre-calcination, the halogen component that has been added as the sintering auxiliary may be burnt and removed together with the gas being circulated, possibly resulting in a decrease in the crystallinity of the final fine particles of magnesium oxide. Thus, it is desirable that any measure be taken to prevent the halogen component from being burnt and removed. The addition of halogen atoms to the fine particles of magnesium oxide enhances the crystallinity of the fine particles and also makes it possible to decrease the calcination temperature. While the calcination temperature of magnesium oxide is generally 2000° C. or above in the conventional techniques, the addition of halogen atoms to the material may decrease the calcination temperature by approximately 500° C. (namely, approximately to 1500° C. or below).

### Embodiment 2

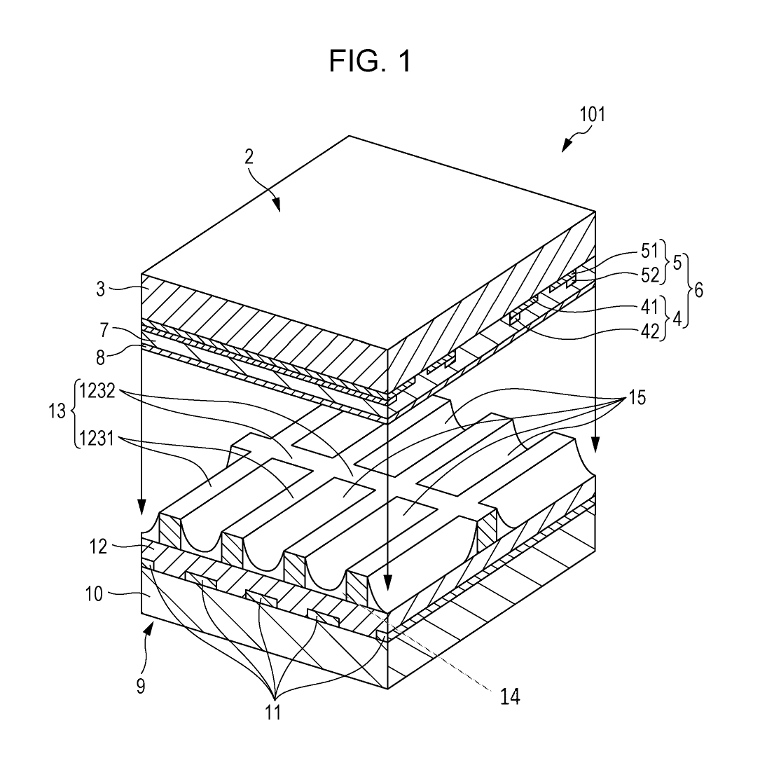

An embodiment of the light-emitting devices will be described. FIG. 1 is a schematic assembly view illustrating discharge cell structures that are discharge units in the light-emitting device of the present disclosure. A light-emitting device 101 includes a front panel 2 and a back panel 9. The front panel 2 includes a front panel substrate (a first substrate) 3, a plurality of display electrode pairs 6 disposed on one side of the front panel substrate 3 wherein each pair consists of a scanning electrode (a first electrode) 5 and a sustaining electrode (a second electrode) 4, a dielectric layer 7 covering the display electrode pairs 6, and a protective layer 8. The scanning electrode 5 and the sustaining electrode 4 each include a transparent electrode 51 or 41 and a bus line 52 or 42 that are stacked together. In each of the display electrode pairs 6, the transparent electrodes 51 and 41 are strips of a transparent conductive material such as indium tin oxide (ITO) or tin oxide (SnO₂). The bus lines 52 and 42 including, for example, Ag thick films, Al thin films or Cr/Cu/Cr stack thin films are disposed on the transparent electrodes 51 and 41. With this configuration, the sheet resistance of the display electrode pairs 6 as a whole may be decreased. The display electrode pairs 6 may be formed by a known thin film production method such as a vacuum deposition method, an ion plating method or a printing method.

When the configuration is such that DUV light is emitted from the front panel 2 side, the front panel substrate 3 and the dielectric layer 7 are desirably made of materials that do not block the passage of DUV light. For example, the front panel substrate 3 may be composed of one selected from the group consisting of quartz glass (SiO₂), magnesium fluoride (MgF₂), calcium fluoride (CaF₂) and lithium fluoride (LiF).

The protective layer 8 serves to protect the dielectric layer 7 and the display electrode pairs 6 from collisions of ions produced by plasma discharge and also to decrease the discharge onset voltage by efficiently releasing secondary electrons. Usually, the protective layer 8 is magnesium oxide having excellent secondary electron release characteristics, sputtering resistance and optical transparency, and is formed by a known thin film production method such as a vacuum deposition method, an ion plating method or a printing method. The protective layer 8 may be such that the phosphor described in Embodiment 1 is disposed on a magnesium oxide (MgO) film formed by a known thin film production method such as a vacuum deposition method, an ion plating method or a printing method.

The back panel 9 includes a back panel substrate (a second substrate) 10 and a plurality of data (address) electrodes 11 for writing data that are disposed on the back panel substrate 10. The data electrodes 11 are arranged so as to intersect with the display electrode pairs 6 of the front panel 2 in an orthogonal direction. The data electrodes 11 include similar materials to the bus lines 52 and 42, such as Ag thick films, Al thin films or Cr/Cu/Cr stack thin films, and are formed by a known thin film production method such as a vacuum deposition method, an ion plating method or a printing method. The data electrodes 11 serve as address electrodes for causing specific regions in the plane of the light-emitting device 101 to emit light. Thus, the data electrodes 11 are not necessarily needed when the light-emitting device 101 is configured to emit DUV light over the entire plane. The back panel substrate 10 further includes a dielectric layer 12 and a phosphor layer 14 covering the data electrodes 11. The dielectric layer 12 is not essential and the configuration may be such that the phosphor layer 14 directly covers the data electrodes 11.

A bulkhead 13 made of a low-melting glass with a prescribed height is disposed on the boundaries of adjacent discharge cells. The bulkhead 13 includes patterns 1231 and 1232 which have such shapes as number signs and thereby defines discharge spaces 15. The bulkhead 13 is produced by applying a low-melting glass material paste and patterning number-sign (#) shapes by a sandblasting method or a photolithographic method so as to create partitions on the boundaries of the adjacent discharge cells, namely, so as to create the arrangements of the discharge cells divided in rows and columns. The bulkhead 13 also serves to prevent the occurrence of unintended discharge or optical crosstalks by partitioning the discharge cells. The bulkhead 13 may be omitted when the light-emitting device 101 is configured to emit DUV light over the full surface. However, the bulkhead 13 may be provided even when the light-emitting device 101 is configured to emit DUV light over the full surface. It is because the bulkhead 13 serves as a spacer to create the discharge spaces between the front panel 2 and the back panel 9. For example, the bulkhead 13 may be formed of stripes or dots in this case. The intervals between the partitions may be adjusted in accordance with the panel size or the emitting area.

The phosphor layer 14 is disposed on the surface of the dielectric layer 12 and on the side surfaces of the bulkhead 13. The phosphor layer 14 is formed by applying and calcining the phosphor described in Embodiment 1. Examples of the application methods include, but are not limited to, spraying methods, electrostatic coating methods, slit coating methods, doctor blade methods and die coating methods. In view of production costs, a general choice is a screen printing method that is widely used as a thick film production technique in industry. The printing method is also advantageous in that the amount of coating may be easily controlled by selecting the solid content of the ink used or by selecting the types of screen meshes.

When the configuration is such that DUV light is emitted from the back panel 9 side, the back panel substrate 10 and the dielectric layer 12 are desirably made of materials that do not block the passage of DUV light. For example, the back panel substrate 10 may be composed of one selected from the group consisting of quartz glass (SiO₂), magnesium fluoride (MgF₂), calcium fluoride (CaF₂) and lithium fluoride (LiF).

The front panel 2 and the back panel 9 are arranged such that the display electrode pairs 6 and the data electrodes 11 are orthogonal to each other with the discharge spaces 15 therebetween. The outer peripheries of the panels 2 and 9 are sealed with a sealing material such as a glass frit or a UV curable resin. The discharge spaces 15 defined in the sealed inside space contain a discharge gas, namely, a rare gas such as Xe—Ne gas or Xe—He gas that is sealed at a pressure of about several tens of kPa.

As described in Embodiment 1, the phosphor constituting the phosphor layer 14 includes fine particles of halogen-containing magnesium oxide.

In the light-emitting device 101, the application of a voltage between the scanning electrode 5 and the sustaining electrode 4 causes the generation of vacuum UV light in the discharge space, the vacuum UV light having a wavelength corresponding to the type of the discharge gas. The vacuum UV light generated is incident as an excitation light on the phosphor of the phosphor layer 14, and consequently the phosphor layer 14 emits DUV light. The DUV light that is produced is emitted to the outside through, for example, the front panel 2.

According to the present embodiment, light-emitting devices that can emit DUV light may be realized without the use of mercury, nitride semiconductors or sapphire substrates. Further, DUV light may be emitted from the entirety of the phosphor layer, and thus the emitting area may be increased easily.

### Embodiment 3

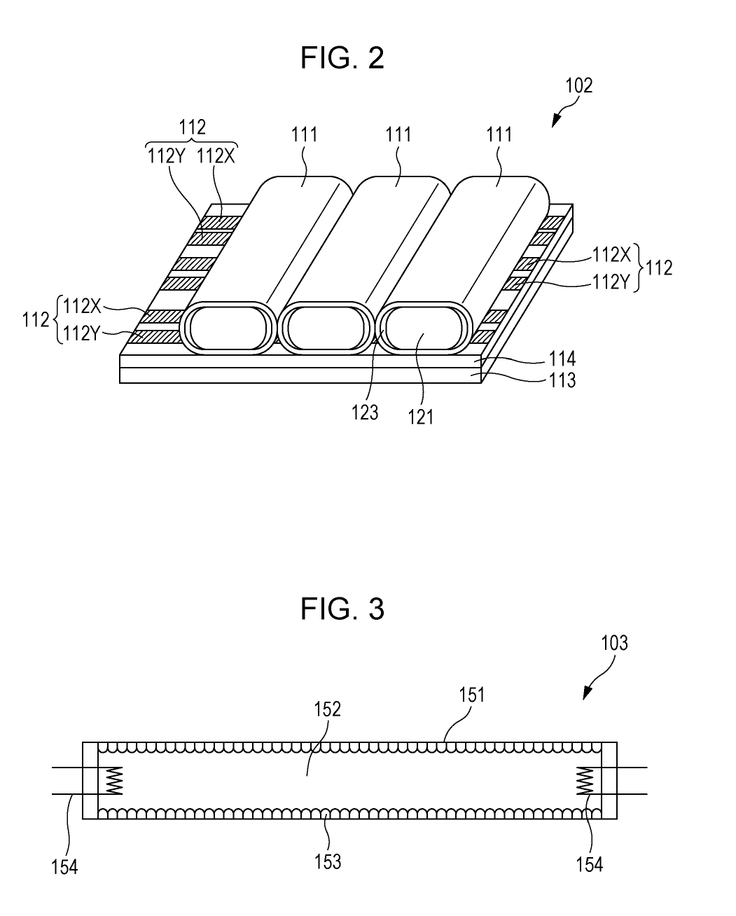

Another embodiment of the light-emitting devices will be described. FIG. 2 illustrates a light-emitting device 102 according to another embodiment of the present disclosure. The light-emitting device 102 includes a plurality of discharge tubes 111, a flexible sheet 113, a reflective layer 114 disposed on the flexible sheet 113, and a plurality of pairs of electrodes 112X and 112Y disposed on the reflective layer 114. For example, the discharge tubes 111 have a flattened elliptical shape in a plane perpendicular to the longitudinal direction, and contain discharge spaces 121 inside the tubes. The discharge spaces contain a discharge gas such as Xe—Ne gas or Xe—He gas. The envelopes of the discharge tubes 111 are made of a material that is transmissive to DUV light. Specifically, the envelopes include one selected from the group consisting of quartz glass, magnesium fluoride, calcium fluoride and lithium fluoride. In the inside of the discharge tubes 111, the phosphor layers 123 containing the phosphor of Embodiment 1 are disposed in contact with the discharge spaces 121.

The pairs of electrodes 112X and 112Y have a shape of stripes extending perpendicularly to the longitudinal direction of the discharge tubes 111, and the conductive members are composed of thin films. The reflective layer 114 is formed of a material capable of reflecting DUV light and is, for example, a metal film. When the reflective layer 114 has conductive properties, an insulating film transmissive to DUV light may be disposed between the pairs of electrodes 112X and 112Y and the reflective layer 114.

In the light-emitting device 102, the application of a voltage between each pair of electrodes 112X and 112Y causes the generation of vacuum UV light in the discharge spaces, the vacuum UV light having a wavelength corresponding to the type of the discharge gas sealed in the discharge tubes 111. The vacuum UV light generated is incident as an excitation light on the phosphor of the phosphor layers 123, and consequently the phosphor layers 123 emit DUV light. The DUV light that is produced is emitted to the outside of the discharge tubes 111. Of the DUV light emitted by the light-emitting device 102, the portion of DUV light emitted toward the flexible sheet 113 is reflected by the reflective layer 114. Thus, the light-emitting device 102 can emit DUV light efficiently toward the side opposite to the flexible sheet 113.

The phosphor in the phosphor layers 123 includes magnesium oxide. Magnesium oxide has excellent secondary electron release characteristics and thus the discharge voltage may be decreased. Further, magnesium oxide can supply a sufficient amount of electrons required for discharge in the discharge spaces to make it possible to produce intense vacuum UV light. Because magnesium oxide eliminates the need of forming a secondary electron release material in the discharge tubes 111, the consequent decrease in the numbers of materials and processes used makes it possible to reduce the costs for the manufacturing of light-emitting devices. The increase in the intensity of vacuum UV light incident on the phosphor layers 123 allows for the emission of DUV light with high efficiency.

The flexible sheet 113 has flexibility. Thus, for example, the light-emitting device 102 may be wound around the exterior of a pipe transmissive to DUV light, and a contaminated or dirty liquid may be passed through the pipe. In this manner, the liquid running inside the pipe may be irradiated with the DUV light with high efficiency.

### Embodiment 4

Another embodiment of the light-emitting devices will be described. As illustrated in FIG. 3, a DUV light-emitting device may be realized by replacing a phosphor of a general fluorescent lamp by the phosphor of Embodiment 1. A light-emitting device 103 includes a discharge tube 151, a discharge space 152 defined inside the discharge tube 151, a phosphor layer 153 disposed on the inner surface of the discharge tube 151, and a discharge gas charged in the discharge space 152. The envelope of the discharge tube 151 includes one selected from the group consisting of quartz glass, magnesium fluoride, calcium fluoride and lithium fluoride. The phosphor layer 153 includes the phosphor of Embodiment 1. At both ends of the discharge tube 151, coiled-coil tungsten filaments 154 coated with an emitter (an electron-releasing substance) are disposed. As already mentioned, the structure of the light-emitting device 103 may be similar to a conventional fluorescent lamp.

In the light-emitting device 103, a voltage applied between the filaments 154 at both ends accelerates electrons released from the filaments 154. The resultant discharge causes Xe in the discharge gas in the discharge space 152 to generate vacuum UV light having wavelengths of 147 nm and 172 nm, and the phosphor in the phosphor layer 153 is excited by the vacuum UV light to emit DUV light.

### Example

Phosphors of Embodiment 1 and light-emitting devices of Embodiment 2 were produced, and their characteristics were evaluated. The results will be discussed later.

### 1. Evaluation of Characteristics of Phosphors

Phosphors of Example were prepared by the method described in Embodiment 1. In Example, commercial magnesium hydroxide was used as the precursor of magnesium oxide, and a commercial magnesium fluoride powder was used as a fluorine source serving also as the sintering auxiliary.

Exactly 200 g of magnesium hydroxide as the magnesium oxide precursor and a prescribed amount of magnesium fluoride were mixed with an ethanol solvent sufficiently in a planetary ball mill which contained zirconia balls having a diameter of 5 mm. Next, the resultant mixture slurry was dried in a hot air dryer at 150° C., placed into a high-purity alumina crucible, and calcined in the air at 1000° C. to 1400° C. for 2 hours, thereby preparing a phosphor. In this Example, the calcination did not involve a pre-calcination step because the amount of the powder to be calcined was small. The calcined fine particles of the deep ultraviolet phosphor were crushed with a mortar. Twenty two samples representing Example were prepared while changing the amount of magnesium fluoride as the sintering auxiliary in the range equal to or more than 0.10 mol % and equal to or less than 1 mol % relative to the total of the precursor and the sintering auxiliary and also changing the calcination temperature in the range equal to or more than 1000° C. and equal to or less than 1400° C.

Next, the following four types of samples representing Comparative Examples were prepared.

In Comparative Example 1, magnesium oxide synthesized by a gas phase synthesis method (gas-phase high-purity ultrafine powder magnesia manufactured by Ube Material Industries, Ltd.) was used.

In Comparative Example 2, magnesium oxide synthesized by a gas phase synthesis method (gas-phase high-purity ultrafine powder magnesia manufactured by Ube Material Industries, Ltd.) was mixed together with the magnesium fluoride powder similarly to Example, and the mixture was calcined at 1300° C.

In Comparative Example 3, fine particles of magnesium oxide were formed by the same method as in Example, except that 0 g of the magnesium fluoride powder as the sintering auxiliary was added for the sintering. Sixteen samples representing Comparative Example 3 were prepared while changing the calcination temperature in the range equal to or more than 1000° C. and equal to or less than 2000° C.

In Comparative Example 4, fine particles of magnesium oxide were formed by the same method as in Example, except that the magnesium fluoride powder as the sintering auxiliary was added at a rate of more than 1 mol % relative to the total of the precursor and the sintering auxiliary. Two samples representing Comparative Example 4 were prepared.

The phosphors of Example and Comparative Examples 1 to 4 were excited by 147 nm vacuum UV light, and the light emitted was measured. Based on the emission spectra obtained, the intensity of peaks observed in the wavelength range of 230±10 nm was calculated. Of the samples representing Example that had been prepared by calcining a mixture of the commercial magnesium hydroxide and the commercial magnesium fluoride powder at 1000° C. to 1400° C., the one prepared at a calcination temperature of 1300° C. exhibited the highest emission intensity. Thus, the emission intensities of the other phosphors were compared relative to the emission intensity of this sample taken as 100.

Further, the samples were subjected to powder X-ray diffractometry using CuKα radiation to determine the full width at half maximum of a (420) diffraction peak observed at a diffraction angle (2θ) equal to or more than 109.0° and equal to or less than 110.0°. Hereinbelow, the full width at half maximum of a (420) diffraction peak will be written as FWHM (420).

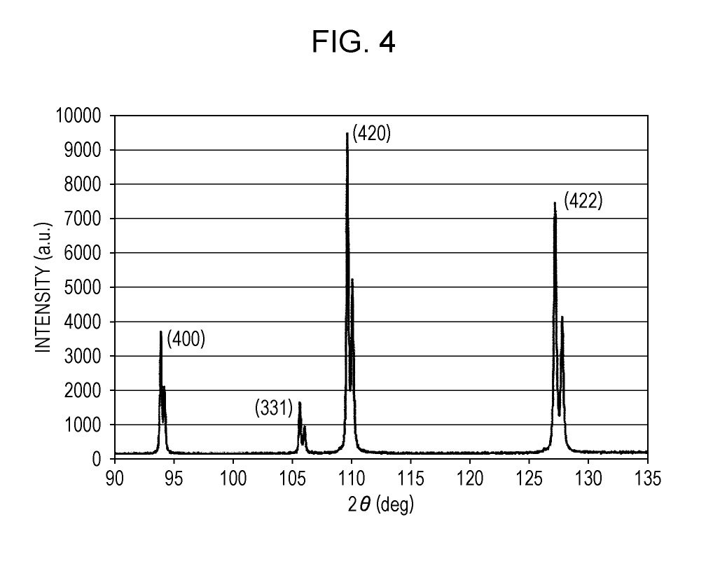

FIG. 4 illustrates an example of the diffraction charts obtained by powder X-ray diffractometry using CuKα radiation in Example. As illustrated in FIG. 4, two (420) peaks were observed because the radiation included CuKα₁ radiation and CuKα₂ radiation. Thus, the peaks were separated using Lorentzian function, and FWHM (420) was determined with respect to the peak obtained with the CuKα₁ radiation.

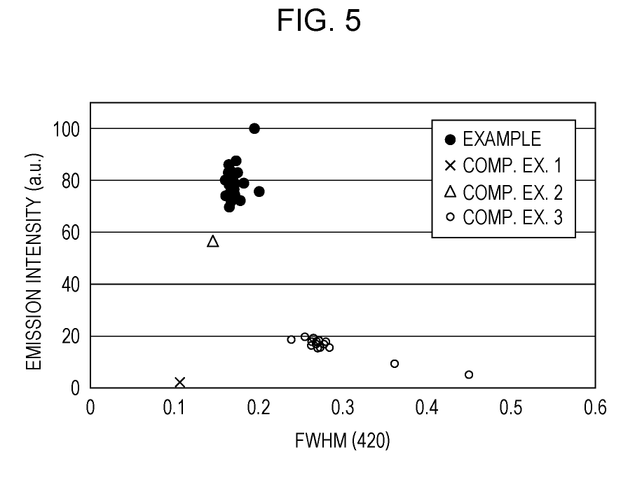

FIG. 5 illustrates relationships between FWHM (420) and the emission intensity in Example and Comparative Examples 1 to 3. In FIG. 5, , x, Δ and ◯ represent Example and Comparative Examples 1, 2 and 3, respectively. From FIG. 5, it has been shown that an emission intensity of 70 or more was obtained when FWHM (420) was in the range of from 0.16° to 0.20°.

The results of Comparative Examples 1 to 3 show that the emission intensity is sharply decreased when FWHM (420) is outside the range of 0.16° to 0.20°. The phosphor of Comparative Example 1 was magnesium oxide obtained by a gas phase synthesis method and had high purity. The value of FWHM (420) is approximately 0.14°, and the crystallinity is considered to be high. However, the emission intensity was as low as about 2. These results show that magnesium oxide having high crystallinity emits a low intensity of DUV light.

On the other hand, FWHM (420) of the phosphors of Comparative Example 3 was greater than 0.25°, indicating low crystallinity. Further, the emission intensities were 20 or below, namely, were less than ⅓ of the intensities obtained in Example. The reason for this result is probably because the phosphors of Comparative Example 3 included various localized levels and emitted fluorescence having wavelengths other than the DUV light wavelengths. Based on the results obtained, it has been demonstrated that the phosphors of Example satisfying the relation (1) achieve a marked enhancement in the emission intensity of DUV light.

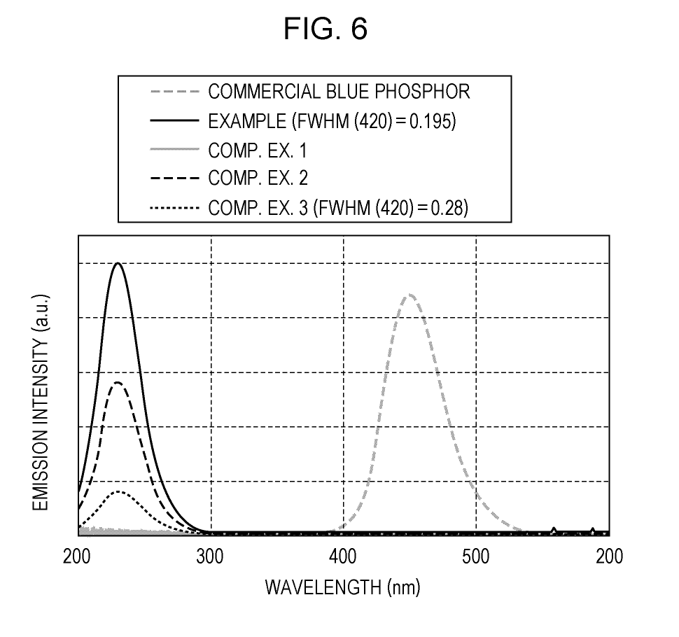

FIG. 6 illustrates emission spectra of the sample of Example (having an emission intensity of 100 in FIG. 5, FWHM (420)=0.195), the samples of Comparative Examples 1 to 3, and a commercial general blue phosphor. As shown in FIG. 6, the phosphor of Example emitted DUV light having a peak at about 230 nm. This emission intensity was approximately of the same level as the emission intensity of the general blue phosphor. Thus, it has been demonstrated that sufficiently practical intensity may be obtained.

In order to confirm the effects of halogens in the phosphors, the fluorine contents in Example and Comparative Examples 3 and 4 were determined. The amount of fluorine present near the surface of the phosphor was determined by X-ray photoelectron spectroscopy (XPS). The analysis involved AlKα radiation (energy: 1487 eV).

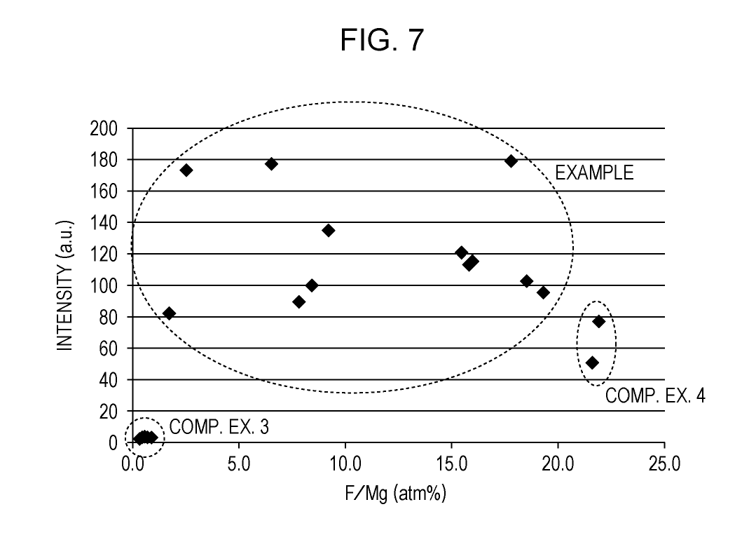

FIG. 7 illustrates relationships between the fluorine content and the emission intensity in Example and Comparative Examples 3 and 4. The emission intensity on the ordinate is indicated with a different scale from FIG. 5. The abscissa indicates the content of fluorine atoms (atm %) relative to one magnesium atom. From FIG. 7, it has been shown that the phosphors of Example contained fluorine at a rate equal to or more than 1.7 atm % and equal to or less than 19.3 atm % relative to one magnesium atom. In the phosphors of Comparative Example 3, the fluorine content was less than 1.7 atm %. Although the synthesis in Comparative Example 3 did not involve the addition of the sintering auxiliary, a trace amount of fluorine was detected probably because of the contamination of fluorine remaining in the furnace during the calcination. The phosphors of Comparative Example 4 contained more than 20 atm % fluorine and exhibited a decrease in emission intensity.

### 2. Evaluation of Light-Emitting Devices

A light-emitting device described in Embodiment 2 was manufactured. First, display electrode pairs 6 were formed on a surface of a front panel substrate 3 made of quartz glass with a thickness of about 1.1 mm. Here, the display electrode pairs 6 were formed by a screen printing method. Specifically, an ITO transparent electrode material was applied onto the front panel substrate 3 in a pattern of stripes having a width of about 150 μm and a final thickness of about 100 nm, and was thereafter dried to form transparent electrodes 41 and 51. Next, a photosensitive paste was prepared by mixing a photosensitive resin (a photodegradable resin) with a Ag powder and an organic vehicle. The paste was applied over the transparent electrodes 41 and 51, and was photoexposed through a mask which had openings corresponding to the pattern of bus lines to be formed (thickness: 7 μm, width: 95 μm). The latent pattern was developed and was calcined at a temperature of about 590° C. to 600° C. Next, the display electrode pairs 6 were coated with a paste that was a mixture of a lead-containing or lead-free low-melting glass with a softening point of 550° C. to 600° C., a SiO₂ material powder and an organic binder including butylcarbitol acetate. The paste was calcined at about 550° C. to 650° C. to give a dielectric layer 7 having a final thickness of several μm to several tens of μm. As a protective layer 8, a MgO thin film having a thickness of about 1 μm was formed by a vacuum deposition method on the dielectric layer 7.

A back panel 9 was fabricated by the following procedures. A bulkhead 13 having a prescribed pattern was formed on a surface of a back panel substrate 10 made of quartz with a thickness of about 1.8 mm. Specifically, this bulkhead 13 was produced by applying a low-melting glass material paste by a screen printing method followed by calcination, and sandblasting the calcined product to form a pattern of stripes on the boundaries of adjacent discharge cells (not shown), namely, to create a pattern of stripes that defined the arrangements of discharge cells in rows and columns. Because the light-emitting device of this Example was a surface-emitting type, the formation of data electrodes 11 and a dielectric layer 12 was omitted.

After the formation of the bulkhead 13, a phosphor that had been prepared was applied to the wall surfaces of the bulkhead 13 and the surface of the quartz back panel substrate 10 exposed from the bulkhead 13. The coating was then dried and calcined to form a phosphor layer 14. Specifically, the phosphor of Example was crushed with a mortar and was mixed together with prescribed amounts of a solvent and a resin in a three-roll mill to give a screen printing ink. By a screen printing method, the ink was applied to the back panel substrate 10 having the bulkhead 13, thereby forming the phosphor layer 14. Thereafter, the film was dried at 100° C. for 1 hour and was calcined at 500° C. for 3 hours, thereby incinerating organic components.

The front panel 2 and the back panel 9 were arranged such that the display electrode pairs 6 were aligned along the centers of the discharge spaces 15 defined by the adjacent walls of the bulkhead 13. The outer peripheries of the panels 2 and 9 were sealed with a UV curable resin. During this process, the sealed inside discharge spaces 15 were filled with Xe—Ne rare gas (Xe partial pressure: 4%) as a discharge gas at a pressure of about 30 kPa.

In the manner described above, an alternate surface-discharge light-emitting device similar to the light-emitting devices described in Embodiment 2 was manufactured.

An AC voltage of several tens of kHz to several hundreds of kHz was applied between each of the display electrode pairs 6. Consequently, discharge was generated in the discharge cells, and the phosphor layer 14 was irradiated with vacuum UV light which included a resonance beam based on 147 nm wavelength emitted by the excited Xe atoms and a molecular beam based on 172 nm wavelength emitted by the excited Xe molecules. The phosphor layer 14 was excited and emitted DUV light. The DUV light produced was emitted from the backside through the back panel 9. Thus, the light-emitting device manufactured was confirmed to emit DUV light similarly to the phosphors of Example.

The phosphors of the present disclosure emit DUV light and may be used in various fields and applications. For example, the phosphors may be used in DUV light-emitting devices. Further, the light-emitting devices of the present disclosure emit DUV light and may be used in various fields such as sterilization, water purification, lithography and illumination.

What is claimed is:

1. A phosphor comprising particles of halogen-containing magnesium oxide, the phosphor emitting DUV light,
the particles satisfying 0.16°≦FWHM (420)≦0.20° wherein FWHM (420) is the full width at half maximum of a (420) diffraction peak present at a diffraction angle 2θ equal to or more than 109.0° and equal to or less than 110.0° as measured by powder X-ray diffractometry using CuKα radiation.

2. The phosphor according to claim 1, wherein the halogen-containing magnesium oxide is fluorine-containing magnesium oxide or chlorine-containing magnesium oxide.

3. The phosphor according to claim 2, wherein the halogen-containing magnesium oxide is the fluorine-containing magnesium oxide, and the particles contain fluorine at a rate equal to or more than 1.7 atm % and equal to or less than 19.3 atm % relative to magnesium.

4. The phosphor according to claim 1, wherein the particles have an average particle diameter equal to or more than 100 nm and equal to or less than 8 μm.

5. The phosphor according to claim 1, wherein the DUV light has a wavelength equal to or more than 200 nm and equal to or less than 300 nm the phosphor emits the DUV light by being excited by vacuum UV light.

6. The phosphor according to claim 1, wherein the particles are particles obtained by mixing a precursor together with a sintering auxiliary including a halogen compound as a source of the halogen, the precursor including at least one selected from the group consisting of magnesium hydroxide, magnesium carbonate, magnesium alkoxide, magnesium nitrate and magnesium acetate, and calcining the mixture at a temperature equal to or more than 1000° C. and equal to or less than 1400° C.

7. A light-emitting device comprising:
a discharge space,
a discharge gas sealed in the discharge space, and
a phosphor disposed in contact with the discharge space,
the phosphor including particles of halogen-containing magnesium oxide, the phosphor emitting DUV light,
the particles satisfying 0.16°≦FWHM (420)≦0.20° wherein FWHM (420) is the full width at half maximum of a (420) diffraction peak present at a diffraction angle 2θ equal to or more than 109.0° equal to or less than 110.0° as measured by powder X-ray diffractometry using CuKα radiation.

8. The light-emitting device according to claim 7, further comprising:
a first substrate including a first electrode, a second electrode and a dielectric layer covering the first electrode and the second electrode, and
a second substrate disposed above the first substrate with a space therebetween, the second substrate being opposed to the dielectric layer,
the space between the first substrate and the second substrate being sealed to define the discharge space containing the discharge gas between the first substrate and the second substrate,
the phosphor being supported on at least one selected from the first substrate and the second substrate, the phosphor being in contact with the discharge space.

9. The light-emitting device according to claim 8, wherein at least one selected from the first substrate and the second substrate includes a material transmissive to the DUV light.

10. The light-emitting device according to claim 9, wherein the material transmissive to the DUV light is one selected from the group consisting of quartz glass, magnesium fluoride, calcium fluoride and lithium fluoride.

11. The light-emitting device according to claim 7, further comprising:
a discharge tube including the discharge space inside thereof, and
at least one pair of electrodes that generate discharge in the discharge space,
the phosphor being disposed inside the discharge tube.

12. The light-emitting device according to claim 7, further comprising:
a plurality of discharge tubes each including the discharge space inside thereof,
at least one pair of electrodes that generate discharge in the discharge space, and
a flexible sheet supporting the plurality of discharge tubes,
the phosphor being disposed inside the discharge tubes.

13. The light-emitting device according to claim 12, further comprising a reflective layer disposed between the plurality of discharge tubes and the flexible sheet.

14. The light-emitting device according to claim 11, wherein the discharge tube includes an envelope defining the discharge space, and the envelope includes one selected from the group consisting of quartz glass, magnesium fluoride, calcium fluoride and lithium fluoride.

15. A phosphor production method comprising:
obtaining a mixture by mixing a precursor together with a sintering auxiliary including a halogen compound as a halogen source, the precursor including at least one selected from the group consisting of magnesium hydroxide, magnesium carbonate, magnesium alkoxide, magnesium nitrate and magnesium acetate, and
obtaining particles of halogen-containing magnesium oxide by calcining the mixture at a temperature equal to or more than 1000° C. equal to or less than 1400° C.,
the particles satisfying 0.16°≦FWHM (420)≦0.20° wherein FWHM (420) is the full width at half maximum of a (420) diffraction peak present at a diffraction angle 2θ equal to or more than 109.0° equal to or less than 110.0° as measured by powder X-ray diffractometry using CuKα radiation.

16. The phosphor production method according to claim 15, wherein the precursor includes the magnesium hydroxide.

17. The phosphor production method according to claim 15, wherein the sintering auxiliary includes at least one selected from the group consisting of magnesium fluoride, magnesium chloride, aluminum fluoride, calcium fluoride, lithium fluoride and sodium chloride.

18. The phosphor production method according to claim 15, wherein the sintering auxiliary is a magnesium halide.

19. The phosphor production method according to claim 15, wherein the mixture contains the sintering auxiliary at a rate equal to or more than 0.10 mol % and equal to or less than 1 mol % relative to the total of the precursor and the sintering auxiliary.

20. A phosphor comprising particles of fluorine-containing magnesium oxide, the phosphor emitting DUV light, the particles containing fluorine at a rate equal to or more than 1.7 atm % and equal to or less than 19.3 atm % relative to magnesium.
